(19) United States
(12) Patent Application Publication
(10) Pub. No.: US 2006/0189347 A1
(43) Pub. Date: Aug. 24, 2006

(54) Wireless phone device flashlight

(76) Inventors: William H. Bollman, Bethesda, MD (US); Barbara Mobille Bollman, Bethesda, MD (US)

Correspondence Address: MANELLI DENISON & SELTER PLLC, 7th Floor, 2000 M Street, N.W., Washington, DC, 20036-3307, US

(21) Appl. No.: 11/061,607

(22) Filed: Feb. 22, 2005

(51) Int. Cl. H04B 1/38; H04M 1/00; H04M 3/00

(52) U.S. Cl. 455/556.1; 455/572

(57) ABSTRACT

A high-intensity LED is integrated into a wireless phone device to provide an extremely convenient flashlight functionality at the ready for a user in possession of their wireless phone, particularly useful in emergency situations. When an emergency or other need emerges suddenly and while the user is otherwise unable to obtain a conventional flashlight, use of a wireless phone flashlight provides a useful source of light for both comfort and safety of the user of the wireless phone device. In another aspect of the invention, the wireless phone flashlight is a peripheral device connected to a digital port of the wireless phone. Alternatively, the flashlight is formed in such a shape as to fit into an external memory card slot of a target wireless phone (e.g., in the shape of a SmartCard), drawing power and even control from the wireless phone through the connector otherwise intended for a memory card.

### BACKGROUND OF THE INVENTION

1. Field of the Invention

This invention relates to wireless telephone devices. More particularly, it relates to peripheral devices integrated into a wireless telephone device.

2. Background of Related Art

Flashlights are well known devices. They are used to illuminate surrounding objects and/or an oncoming pathway. They are used to provide the feeling of safety in a dark room. Some children even use them as a nightlight.

While flashlights are useful devices, not all people carry one at all times. In fact, most people do not carry a flashlight at all times. Rather, many people keep a flashlight in an easily accessible location should the need arise.

In today's ever-mobile society, one finds themselves often not at home, near their flashlight. For instance, should the need arise for a flashlight while on a family vacation away from home, one would need to obtain one from a store, hotel concierge, etc. This is not always the most convenient method. Moreover, in extreme needs such as a power outage, the demand for flashlights is high. If you don't get to a store immediately to buy a flashlight (presuming that the store is open during the power outage), they will more than likely be sold out.

Existing flashlights are bulky, formed from relatively unreliable incandescent bulbs, and are mechanically operated, again adding to unreliability, bulk and costs.

In short, when away from home, unless you carry a flashlight with you at all times, obtaining one during a time of need will be at best inconvenient. There is a need for a convenient and functional illumination device that will have a likelihood of availability in your moment of need.

### SUMMARY OF THE INVENTION

In accordance with the principles of the present invention, an improvement to an otherwise conventional wireless phone device includes a flashlight powered by a battery used to also power the wireless phone device.

In accordance with another aspect of the invention, a wireless phone comprises a wireless phone functionality module, and an LED flashlight operable under software control. A wireless phone battery is adapted to power both the wireless phone functionality module and the flashlight.

In accordance with yet another aspect of the invention, a wireless phone flashlight comprises a flashlight, and a connector interface adapted for interconnection with and software control through a digital port of a wireless phone.

A method and apparatus for providing illumination of objects surrounding a wireless phone in accordance with still another aspect of the invention comprises activating at least one button on a wireless phone to cause software control to turn on an LED flashlight within the wireless phone. Current is then caused to flow through the LED flashlight, thus providing illumination of objects surrounding the wireless phone for a user of the wireless phone.

### BRIEF DESCRIPTION OF THE DRAWINGS

Features and advantages of the present invention will become apparent to those skilled in the art from the following description with reference to the drawings, in which:

FIG. 1 shows an exemplary wireless digital phone including an LED flashlight, in accordance with the principles of the present invention.

FIG. 2 shows a functional schematic diagram for the exemplary wireless digital phone shown in FIG. 1.

FIG. 3 shows an exemplary method of turning a wireless digital phone flashlight ON and OFF through software control, in accordance with the principles of the present invention.

### DETAILED DESCRIPTION OF THE ILLUSTRATIVE EMBODIMENTS

Wireless phones have become ubiquitous with everyday life. Many people carry them constantly. The present invention mates the high likelihood that a user will have a wireless device in a time of need for a flashlight, and the functionality of a flashlight.

In accordance with the principles of the present invention, a high-intensity white LED is integrated into a wireless phone device to provide an extremely convenient flashlight functionality at the ready for a user in possession of their wireless phone, particularly useful in emergency situations. When an emergency or other need emerges suddenly and while the user is otherwise unable to obtain a conventional flashlight, use of a wireless phone flashlight provides a useful source of light for both comfort and safety of the user of the wireless phone device.

In another aspect of the invention, the wireless phone flashlight may be provided in or near a digital port of a wireless phone. Alternatively, the LED flashlight is formed in such a shape as to fit into an external memory card slot of a target wireless phone (e.g., in the shape of a SmartCard), drawing power and even control from the wireless phone through the connector otherwise intended for a memory card.

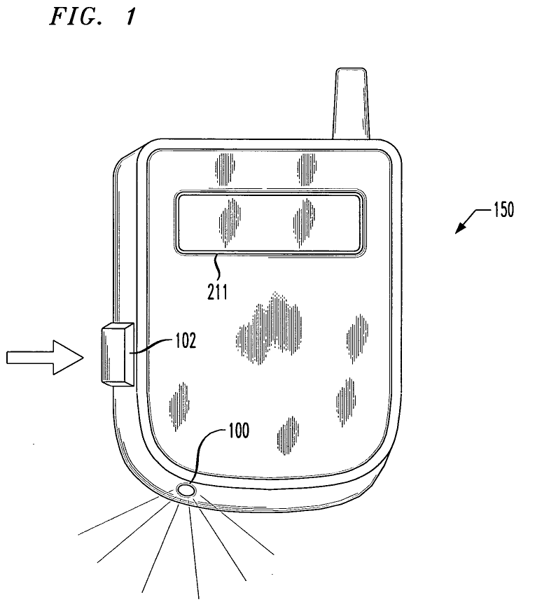

FIG. 1 shows an exemplary wireless phone including a flashlight, in accordance with the principles of the present invention.

In particular, FIG. 1 shows a wireless phone 150 including a flashlight 100. In the given embodiment, a software-detected button 102 causes operation of the illuminating high-intensity light-emitting-diode (LED) forming the flashlight 100. Of course, the button 102 may be replaced by a sequence of presses of an alphanumeric keypad or other conventional phone keypad buttons, such as would be necessary to navigate through a menu-driven user interface to select operation of the flashlight 100.

It is important that the flashlight 100 be operated under the control of software, instead of mechanically operated, to allow intelligent battery conservation. For instance, as the battery nears depletion, if the flashlight 100 is at the time in an ON condition, it would be desirable to automatically turn the flashlight 100 OFF, so as to maximize minimal operations of the wireless phone functions.

The flashlight 100 may be physically located on any suitable external surface of the wireless device 150. This includes location on a flip phone as shown in FIG. 1, as well as on a non-flip wireless phone. I the case of a flip phone, the flashlight 100 may alternatively be located on any of the inside surfaces of the flip phone that become outside surfaces only when the wireless phone 150 is opened.

The illuminating element of the flashlight 100 is preferably a light emitting diode (LED), and more preferably a high intensity white LED. An LED is much preferred by the present inventor for its reliability, long rated lifetime, as well as its ease of integration into circuit board manufacture. Incandescent bulbs are larger, have much shorter lifespans, are relatively unreliable, are difficult if at all possible to mount directly to a printed circuit board (adding costs), and require replacement, making them undesirable in the present application.

The particular LED or other illuminating element is preferably selected based on the available power supply level (e.g., 2.4V, 3.7V, 5V, 12V, etc.), the desired illumination intensity at that available power supply level, reliability, and to a lesser extent rated lifetime (presuming the lifetime of the LED will be much longer than its expected use).

A small reflector may be formed behind the high intensity LED of the flashlight 100, to direct all light forwards and/or to focus the light in a given direction. The reflector may be formed into a small cavity formed in the plastic of the case of the wireless phone 150. Preferably, but not necessarily, the small cavity is coated with a highly reflective coating.

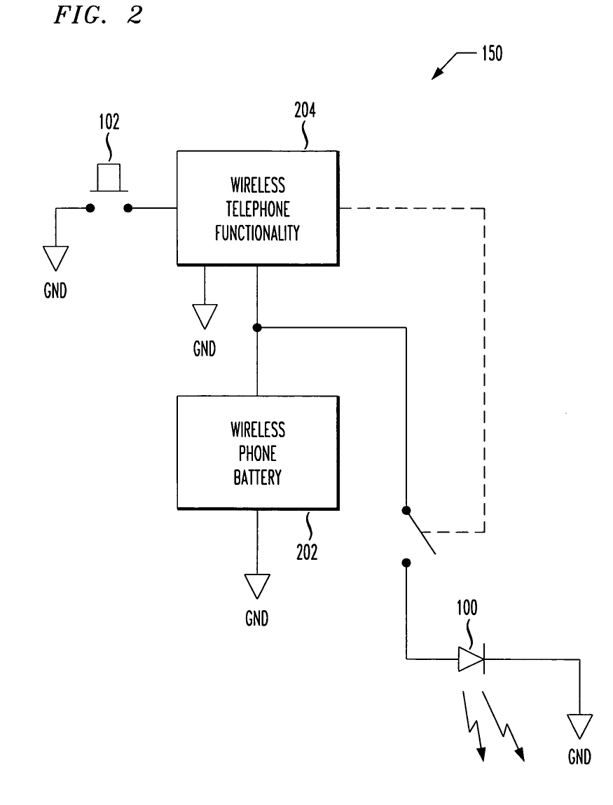

FIG. 2 shows a functional schematic diagram for the exemplary wireless phone shown in FIG. 1.

In particular, as shown in FIG. 2, the LED of the flashlight 100 is powered from a wireless phone battery 202, which also powers wireless telephone functionality 204 in the wireless phone 150. In the given embodiment, the flashlight 100 is controlled ON and OFF by operation of software of the wireless phone device.

The switch 102 shown in FIG. 2 can be a mechanical switch sensed by software, or a virtual switch operated through a defined series of alphanumeric or other keys on the otherwise conventional wireless phone, or through checkbox type selection in an appropriate pull-down or other type menu in a graphical user software interface.

The switch 102 (whether mechanical or virtual) may operate as a momentary type switch, or as an ON/OFF type switch. A momentary function would turn the flashlight 100 ON only while the switch 102 is activated: when released, the flashlight 100 would turn off. If an ON/OFF type switching function, the flashlight 100 would turn ON when the switch 102 is activated, and remain ON until the switch 102 is deactivated, at which time the software would cause current to cease flow to the flashlight 100, which would then be turned OFF.

The switch 102 is preferably a virtual switch, operable under software control. In the disclosed embodiment, the switch 102 is activated and deactivated through a predefined series of button presses that navigate a user through one or more pages of a menu through a graphical user interface (GUI) on a screen of the wireless phone. For instance, a user may navigate to a SETTINGS menu for their wireless phone, and select a checkbox to turn the flashlight ON. Normal wireless phone functionality is preferably possible at all times. Thus, a phone call may be placed or received while the flashlight 100 is turned ON. For convenience, and for battery conservation, it may be preferably to automatically turn the flashlight 100 OFF during an active phone call. In such a case, it is also preferably to automatically turn the flashlight 100 back ON after the phone call, if the switch 102 (e.g., menu checkbox) remains activated.

Preferably, the flashlight 100 would be controlled ON and OFF through a software controllable element, to allow automatic shut OFF of the flashlight 100 if and when the battery power becomes low. An element such as a power transistor or other transistor may form a virtual switch to turn the flashlight 100 ON and OFF, though mechanical switching of the flashlight 100, e.g., using a mechanical relay, is also within the spirit of the present invention.

The software controllable element to power the flashlight 100 ON and OFF can be a transistor of any suitable type, e.g., CMOS, MOSFET, etc., that is rated to sufficiently and reliably control current to the LED of the flashlight 100.

Preferably the wireless phone remains on and capable of receiving an incoming telephone call while the flashlight 100 is ON. In one aspect, if an incoming call is answered, the flashlight 100 may be automatically turned off to answer the call. Similarly, and/or alternatively, the flashlight 100 may be turned off when an outgoing call is placed.

The flashlight 100 may be turned OFF when the wireless phone 150 is powered down. If desirable, the flashlight 100 may then remain OFF even after powering the wireless phone 150 back up, providing a convenient way to turn the flashlight 100 off after use.

The flashlight 100 may be automatically powered OFF when the wireless phone battery 202 is detected to have less than a threshold amount of power remaining. If the flashlight 100 is to be powered OFF, preferably a warning sound and/or textual message will be provided to the user of the wireless phone 150 providing them warning beforehand.

The high intensity LED of the flashlight 100 is preferably an LED, and more preferably an LED providing light primarily in the visible spectrum (e.g., a white LED), and one that is intended for use to provide visual illumination of surrounding objects some distance from the LED, as is typical for use as a flashlight.

While a single LED is shown in the flashlight 100 in FIG. 2, more than one LED may be used to provide additional light intensity.

Current to the flashlight 100 may be a constant current to provide maximum intensity. However, to conserve battery power, the flashlight 100 may be powered with a pulsed current (e.g., a less-than-100% duty cycle current pulse such as a 50% duty cycle current pulse). The pulse is preferably a square wave pulse, though an AC sine wave pulse is also possible and within the spirit of the present invention.

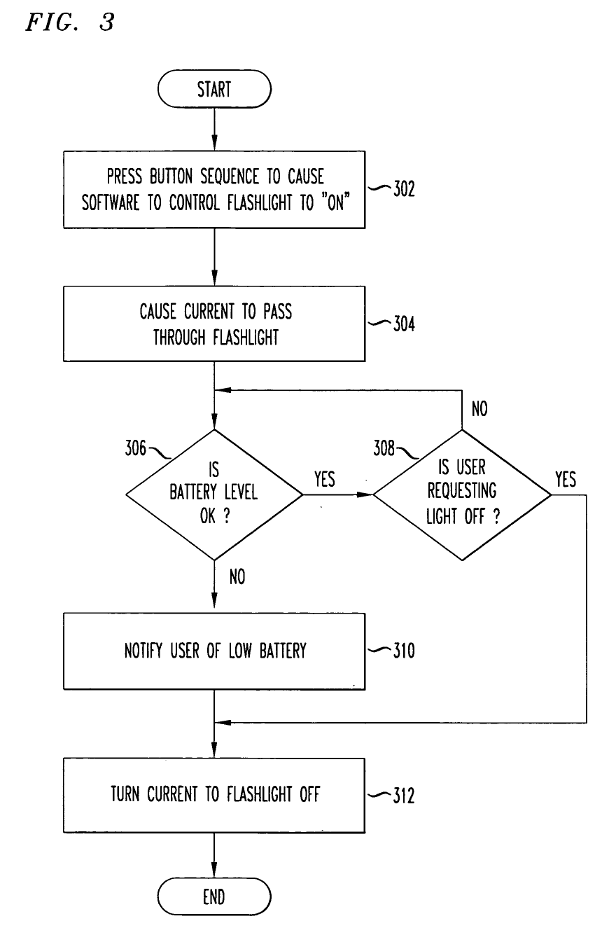

The wireless phone battery 202 is preferably an integrated battery used for otherwise conventional wireless phone functionality (e.g., Li-ion, NiMH, etc.) FIG. 3 shows an exemplary method of turning a wireless telephone flashlight ON and OFF, in accordance with the principles of the present invention.

In particular, as shown in step 302 of FIG. 3, a button (or sequence of buttons such as navigating through a menu) is pressed to cause software operating on the wireless phone to control the flashlight 100 to an ON or illuminating condition.

In step 304, in response to the user command to cause software to control the flashlight 100 to an ON condition, current is caused to pass through the flashlight 100, thus turning the flashlight 1000N. The current is preferably caused to pass through the flashlight 100 using an appropriate transistor device.

Step 306 is useful to conserve battery power when the voltage level of the wireless phone battery 202 drops to a very low (i.e., almost depleted) state. In step 306, the wireless telephone functionality detects the level of power remaining in the wireless phone battery 202 in an otherwise conventional manner.

If the battery level is detected as being OK, or above a given low power threshold, then the method loops. In the endless loop, additional operations may be sensed on the wireless phone 150, such as if/when the user has pressed a button or buttons indicating that they want the flashlight 100 turned OFF, as shown in step 308.

If the battery level is detected as being below a given low power threshold, then the method of FIG. 3 jumps to step 310, where the user is notified of the low battery condition with an audible and/or visual warning. Of course, such notification is desirable, but not absolutely necessary. Then the current switch allowing current to flow through the flashlight 100 is opened, or turned OFF, ceasing battery usage by the flashlight 100 and also the illumination provided thereby. The flashlight 100 is thus turned OFF.

While the present invention is shown in its preferred form with the flashlight 100 integrated within the body of the wireless phone, a less desirable embodiment may be utilized wherein the flashlight 100 is installed post-manufacture of the wireless device. For instance, the flashlight 100 may be installed into a digital port (e.g., a Universal Serial Bus (USB) port), memory card slot, etc.) For instance, the flashlight 100 may be formed in a device that inserts into a digital port of a conventional wireless phone.

In any event, it is important that the flashlight 100 be non-bulky, and essentially not noticed by the user until the time in which they need it. Thus, if the flashlight 100 is such a post-manufacture device, it is important that the flashlight 100 be integral to the wireless phone, and non-encumbering. It is important that the flashlight be unobtrusive, and essentially unnoticed by the user—until the time in which the user has need for the flashlight 100.

In such an embodiment, power is drawn from the wireless device battery through the digital port or memory card slot, whichever is used to power and control operations of the flashlight 100. Software control of the flashlight 100 is also passed through the digital port or memory card slot in such embodiment.

Operation of such a peripheral flashlight 100 is preferably via software in the wireless phone that controls the digital port in such a way as to operate the flashlight 1000N and OFF through a menu selection or other software-detected button sequence.

The peripheral flashlight may alternatively be formed largely in the shape and/or size of an external memory card utilized by the wireless phone, e.g., a SmartCard or other standardized memory card. Such peripheral would include a connector commensurate with the connector of a suitable memory card, utilizing necessary signals such as power and ground. The memory card-shaped peripheral is inserted into an otherwise conventional wireless phone in place of a memory card, and operated as described with respect to the techniques shown in FIG. 3.

A wireless phone device, or wireless phone, as disclosed herein is understood to be any device such as a cell phone, personal digital assistant (PDA), Blackberry™, or other wireless device capable of wireless voice communications.

While the invention has been described with reference to the exemplary embodiments thereof, those skilled in the art will be able to make various modifications to the described embodiments of the invention without departing from the true spirit and scope of the invention.

1. In a wireless phone device having wireless phone capabilities, the improvement comprising:
a light emitting diode (LED) flashlight powered by a battery used to also power said wireless phone device;
wherein said LED flashlight is operable under software control; and
said flashlight is operable to automatically turn OFF before said battery becomes depleted.

2. In a wireless phone device having wireless phone capabilities according to claim 1, wherein:
said LED flashlight is operable to automatically turn OFF when a battery power level serving both a wireless phone functionality and said LED flashlight drops below a predetermined low power threshold level still allowing at least minimal functionality of said wireless phone functionality.

3. In a wireless phone device having wireless phone capabilities according to claim 1, wherein:
said wireless phone device is a cellular phone.

4. In a wireless phone device having wireless phone capabilities according to claim 3, wherein said LED flashlight comprises:
a high intensity white LED.

5. In a wireless phone device having wireless phone capabilities according to claim 1, wherein:
said wireless phone is a digital wireless phone.

6. In a wireless phone device having wireless phone capabilities according to claim 1, wherein:
said wireless phone is capable of wireless voice communications via a GSM standard.

7. In a wireless phone device having wireless phone capabilities according to claim 1, wherein:
said wireless phone is capable of wireless voice communications via an IS-41 standard.

8. A wireless phone, comprising:
a wireless phone functionality module;
a light emitting diode (LED) flashlight operable under software control; and
a wireless phone battery adapted to power both said wireless phone functionality module and said LED flashlight;
wherein said LED flashlight is operable to automatically turn OFF before said battery becomes depleted.

9. The wireless phone according to claim 8, further comprising:
a software menu adapted for controlling said LED flashlight to ON and OFF conditions.

10. The wireless phone according to claim 8, wherein:
said LED flashlight is operable to automatically turn OFF when a battery power level serving both a wireless phone functionality and said LED flashlight drops below a predetermined low power threshold level still allowing at least minimal functionality of said wireless phone functionality.

11. The wireless phone according to claim 8, wherein:
said wireless phone is a cellular phone.

12. The wireless phone according to claim 11, wherein said LED flashlight comprises:
a high intensity white LED.

13. The wireless phone according to claim 8, wherein:
said wireless phone is a digital wireless phone.

14. The wireless phone according to claim 8, wherein:
said wireless phone is capable of wireless voice communications via a GSM standard.

15. The wireless phone according to claim 8, wherein:
said wireless phone is capable of wireless voice communications via an IS-41 standard.

16. A wireless phone flashlight, comprising:
a flashlight; and
a connector interface adapted for interconnection with, and software control through, a digital port of a wireless phone.

17. The wireless phone flashlight according to claim 16, wherein:
said wireless phone flashlight is shaped to fit in an external memory card slot of said wireless phone.

18. A method of providing illumination of objects surrounding a wireless phone, comprising:
allowing activation of at least one button on a wireless phone to cause software control to turn on a flashlight integrated within said wireless phone;
causing current to flow through said flashlight, thus providing illumination of objects surrounding said wireless phone for a user of said wireless phone; and
automatically powering said flashlight OFF before a battery serving both a wireless phone functionality and said flashlight becomes depleted.

19. The method of providing illumination of objects surrounding a wireless phone according to claim 18, wherein:
said flashlight is a light emitting diode (LED) flashlight.

20. The method of providing illumination of objects surrounding a wireless phone according to claim 18, wherein:
said step of activating comprises navigating through at least one page of a menu driven graphical user interface.

21. (canceled)

22. Apparatus for providing illumination of objects surrounding a wireless phone, comprising:
means for activating at least one button on a wireless phone to cause software control to turn on a flashlight integrated within said wireless phone; and
means for causing current to flow through said flashlight, thus providing illumination of objects surrounding said wireless phone for a user of said wireless phone; and
means for automatically powering said flashlight OFF before a battery serving both a wireless phone functionality and said flashlight becomes depleted.

23. The apparatus for providing illumination of objects surrounding a wireless phone according to claim 22, wherein:
said flashlight is a light emitting diode (LED) flashlight.

24. The apparatus for providing illumination of objects surrounding a wireless phone according to claim 22, wherein said means for activating comprises:
means for navigating through at least one page of a menu driven graphical user interface.

25. The apparatus for providing illumination of objects surrounding a wireless phone according to claim 22, further comprising:
means for automatically powering said flashlight OFF when a battery power level serving both a wireless phone functionality and said flashlight drops below a predetermined low power threshold level.

26. The apparatus for providing illumination of objects surrounding a wireless phone according to claim 22, wherein:
said means for automatically powering said flashlight OFF before a battery serving both a wireless phone functionality and said flashlight becomes depleted powers said flashlight OFF when a power level of said battery drops below a predetermined minimal power threshold level still allowing at least minimal use of said wireless phone functionality.

27. The apparatus for providing illumination of objects surrounding a wireless phone according to claim 26, wherein:
said cellular phone is a digital cellular phone.

28. In a wireless phone device having wireless phone capabilities according to claim 1, wherein:
said LED flashlight is illuminated using a pulsed current having a given duty cycle.

29. The wireless phone according to claim 8, wherein:
said LED flashlight is illuminated using a pulsed current having a given duty cycle.

30. The method of providing illumination of objects surrounding a wireless phone according to claim 18, wherein:
said current is caused to pulse through said flashlight with a given duty cycle.

31. The apparatus for providing illumination of objects surrounding a wireless phone according to claim 22, wherein:
said current is caused to pulse through said flashlight with a given duty cycle.

32. A wireless phone, comprising:
a wireless phone functionality module;
a light emitting diode (LED) flashlight operable under software control; and
a wireless phone battery adapted to power both said wireless phone functionality module and said LED flashlight;
wherein said flashlight is operable to automatically turn OFF during an active call on said wireless phone functionality module.

33. A wireless phone, comprising:
a wireless phone functionality module;
a light emitting diode (LED) flashlight operable under software control; and
a wireless phone battery adapted to power both said wireless phone functionality module and said LED flashlight;
wherein said flashlight is operable to automatically turn OFF when accepting an incoming call on said wireless phone functionality module.
